(19) United States
(12) Patent Application Publication
(10) Pub. No.: US 2011/0115612 A1
(43) Pub. Date: May 19, 2011

(54) MEDIA MANAGEMENT SYSTEM FOR SELECTIVELY ASSOCIATING MEDIA WITH DEVICES DETECTED BY AN RFID

(76) Inventors: Joseph M. Kulinets, North Andover, MA (US); Peter R. Nuytkens, Melrose, MA (US)

(21) Appl. No.: 12/620,377

(22) Filed: Nov. 17, 2009

(51) Int. Cl. G06K 7/01; H04N 5/232; G06F 15/16

(52) U.S. Cl. 340/10.42; 348/211.6; 709/203; 381/122

(57) ABSTRACT

A system and method for managing media is described herein. The system includes a camera oriented towards a visually distinguishing mark, at least one actuation device that generates an instruction for at least one of the camera and an RFID reading system, and a central control unit in communication with the camera and the RFID reading system. In response to an instruction from the at least one actuation device, the RFID reading system detects an RFID device neighboring the visually distinguishing mark and transmits a first identifying information of the detected RFID device to the central control unit. The central control unit receives an image captured by the camera, creates a media file including the captured image and the received first identifying information, and transmits the media file to a server.

### BACKGROUND

1. Technical Field

The present application is directed generally to a media management system and, in particular, to a media management system for capturing images, detecting RFID devices, and generating media files associating the captured images with the detected RFID devices.

2. Description of Related Art

Thanks in part to recent technological advances, images are easily captured using not only conventional cameras, but also various consumer appliances equipped with photo capturing capabilities. As such, the general public is much more adept at capturing images, videos, etc. However, many practical considerations remain. For example, it is often difficult to take an image in particular settings, such as museums, where picture taking is often prohibited, or in water parks, where photography equipment can become damaged. Additionally, it can be difficult to obtain unique perspectives, such as the view at the top of a roller coaster in an amusement park.

Various photography systems have been proposed to address these issues. For example, many locations have installed photography systems for taking pictures that customers would not be otherwise permitted or able to take. However, these systems permit no input from the customer as to the characteristics of the image. That is, the customer has absolutely no control over the capturing of the image. In addition, these systems require registration by a customer. The registration process requires, inter alia, personal identifying information from a customer. This identifying information is stored and later associated with an image. In other examples, the system automatically, and often times randomly, captures images of the customer and later associates the image data to the identifying information. Sometimes, the image data obtained throughout the session is stored together with the identifying information of the customer.

The present disclosure is directed to an improved image management system that permits the customer to control the camera and that requires no registration by the customer.

### SUMMARY

According to the present disclosure, visitors to a site can each obtain an RFID device to track images taken by the site's media capturing centers. Whenever a visitor wants a media capturing center to take an image of him, the visitor can actuate an actuation device of the center. The RFID reading system detects the visitor's RFID device and the a camera captures the visitor's image. The media capturing center creates a media file including the captured image and the identifying information of the RFID device, and a media server stores the file. The visitor can later retrieve the media files using information of his RFID device.

In one aspect, the present disclosure relates to a media management system. The system includes a camera oriented towards a visually distinguishing mark, at least one actuation device that generates an instruction for at least one of the camera and an RFID reading system, and a central control unit in communication with the camera and the RFID reading system. In response to an instruction from the at least one actuation device, the RFID reading system detects an RFID device neighboring the visually distinguishing mark and transmits a first identifying information of the detected RFID device to the central control unit. Further, the central control unit receives an image captured by the camera, creates a media file including the captured image and the received first identifying information, and transmits the media file to a server.

The RFID reading system can also include a plurality of antennae positioned near the visually distinguishing mark to define an area where the RFID reading system detects the RFID device. The server can store the media file according to the first identifying information in the media file. The at least one actuation device can be triggered to transmit one of a zoom instruction, a pan instruction, and a media capture instruction to the camera. The camera can capture an image in response to detection, by a sensor, of movement proximate to the visually distinguishing mark. The central control unit can store in a queue a plurality of first identifying information of RFID devices detected by the RFID reading system, receive the captured image from the camera, and retrieve the first identifying information from the queue to include in the media file with the captured image.

The system can also include a display device that renders image data obtained by the camera. The system can also include a microphone and a recorder for capturing audio, wherein the media file includes the captured audio. The RFID device can be at least one of a wristband, a badge, and a card. The system can also include a media output terminal that receives second identifying information from a customer, derives the first identifying information from the second identifying information, retrieves media files corresponding to the first identifying information from the server, and transfers media from the media files to at least one of a printer, a storage media, and a computing device.

In another aspect, the present disclosure relates to a method of managing media. The method includes receiving, by a remote control unit, an instruction from a first actuation device to an RFID reading system to detect an RFID device; actuating, by the remote control unit, the RFID reading system in response to the instruction; detecting, by the RFID reading system, the RFID device neighboring a visually distinguishing mark; transmitting, by the RFID reading system, first identifying information of the RFID device to a central control unit; capturing, by a camera oriented towards the visually distinguishing mark, an image; creating, by the central control unit, a media file including the first identifying information and the captured image; and transmitting, by the central control unit, the media file to a server.

The method can also include positioning a plurality of antennae of the RFID reading system near the visually distinguishing mark to define an area where the RFID reading system communicates with the RFID device. The method can also include storing, by the server, the media file according to the first identifying information in the media file. The method can also include receiving, by a second actuation device, an instruction to the camera to one of zoom, pan, and capture media. The camera can capture an image in response to detection, by a sensor, of movement proximate to the visually distinguishing marks.

The method can also include storing, by the central control unit, in a queue a plurality of first identifying information of RFID devices detected by the RFID reading system; receiving, by the central control unit, the captured image from the camera; and retrieving, by the central control unit, first identifying information from the queue to include in the media file with the captured image. The method can also include displaying, by a display device, image data obtained by the camera. The method can also include capturing, by a microphone and recorder, audio to be included in the media file. The method can also include receiving, by a media output terminal, second identifying information from a customer; deriving, by the media output terminal, the first identifying information of the RFID device from the received second identifying information; retrieving, by the media output terminal, media files from the server according to the first identifying information; and transferring, by the media output terminal, the media files to at least one of a printer, a storage media, and a computing device.

In a third aspect, the present disclosure relates to a media management system. The system includes an image capturing device oriented towards a visually distinguishing mark; an actuation device positioned proximate to the visually distinguishing mark, the actuation device generating an instruction for at least one operation of the image capturing device; and an RFID reading system in communication with a central control unit, the RFID reading system configured to detect an RFID device proximate to the visually distinguishing mark. The central control unit is in communication with the image capturing device. The central control unit creates a media file in response to operation of the image capturing device. The media file includes an image captured by the image capturing device and identifying information of the detected RFID device.

### BRIEF DESCRIPTION OF THE DRAWINGS

The foregoing and other objects, aspects, features, and advantages of the present disclosure will become more apparent by referring to the following description taken in conjunction with the accompanying drawings, in which:

FIG. 1 is an exemplary block diagram of a media management system;

FIG. 2 is an exemplary block diagram of a first embodiment of a media capturing center used in the media management system of FIG. 1;

FIG. 3 is an exemplary block diagram of a second embodiment of a media capturing center used in the media management system of FIG. 1;

FIGS. 4A-4C depicts RFID devices, used with the media capturing centers, in accordance with the present disclosure, as a wristband, a card, and a badge; and

FIG. 5 is an exemplary block diagram of a media output terminal of the media management system, in accordance with the present disclosure.

### DETAILED DESCRIPTION

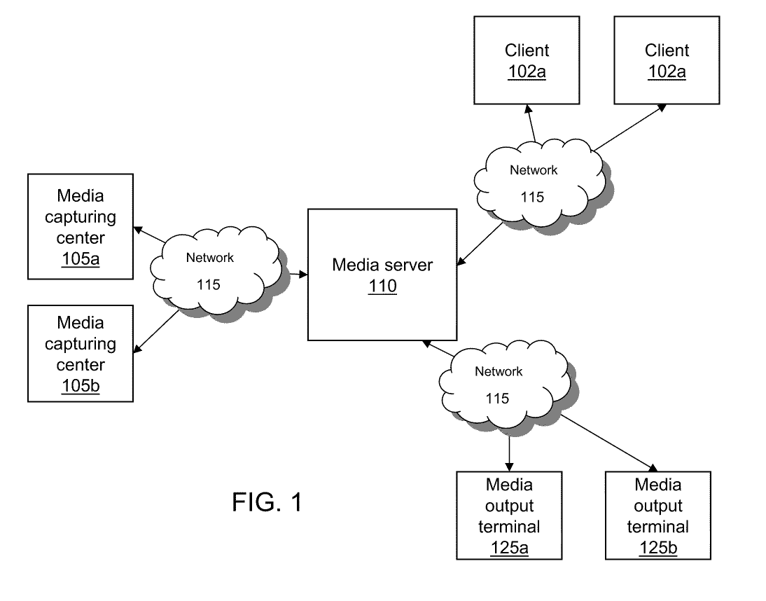

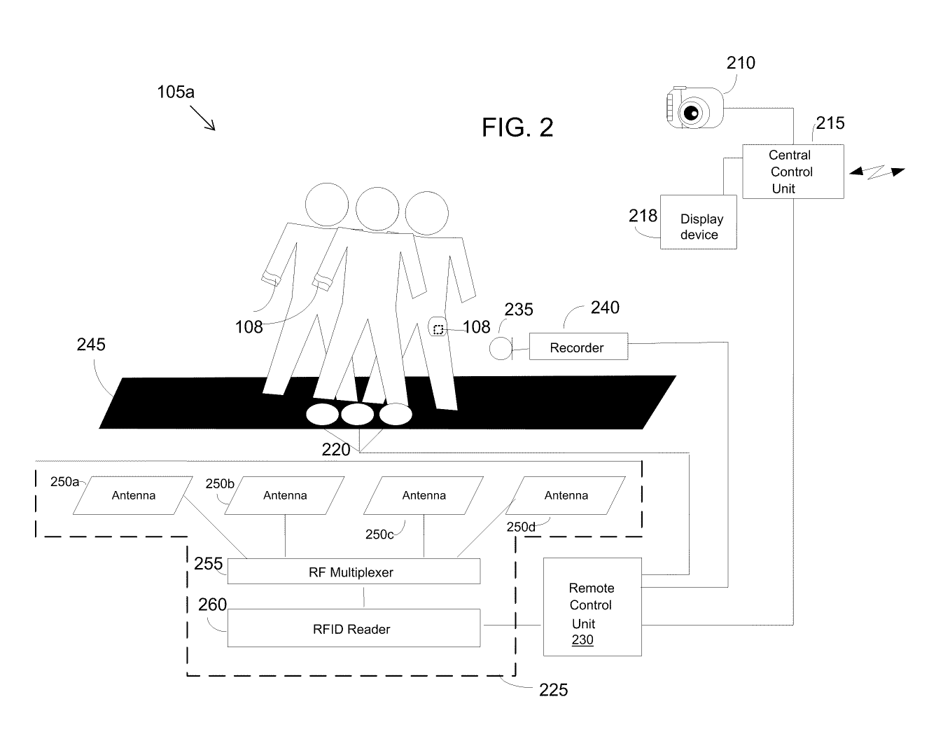

Referring now to FIG. 1, an exemplary block diagram of a media management system 100 is shown and described. In brief overview, the media management system 100 includes a plurality of media capturing centers 105a, 105b (collectively, “105”) in communication with a media server 110 over a network 115. When an actuation device of a media capturing center 105 is triggered, the media capturing center 105 detects at least one RFID device 108 (FIG. 2), in a manner described in detail herein below. In accordance with the present disclosure, the media capturing center 105 captures media (e.g., still images, video, and/or audio) and associates identifying information (e.g., a serial number) of a detected RFID device 108 with the captured media to create a media file (not shown). The media capturing center 105 transmits the media file to the media server 110 for storage in a database. The media server 110 stores each media file according to the identifying information of the RFID device in the media file.

Customers can later retrieve media files from the media server 110 for viewing and/or purchase. Customers can use client devices 120a, 120b (collectively, “120”), such as computing devices capable of communicating over networks 115, to retrieve media files from the media server 110. Customers can also retrieve media files via media output terminals 125a, 125b (collectively, “125”), also in communication with the media server 110 over the network 115. Through either the client device 102 or the media output terminal, a customer can input identifying information of at least one RFID device. The media server 110 can retrieve and return media files associated with the RFID device(s) 108 to the customer. Then, the customer can edit the media files, place an order for desired media, and pay for the order.

Referring now to FIG. 2, an embodiment of a media capturing center 105a is shown and described. In brief overview, the media capturing center 105a includes an image capturing device (e.g., camera 210) controlled by a central control unit 215, and an RFID reading system 225. When one of the actuation devices 220 is triggered, the remote control unit 230 instructs the RFID reading system 225 to detect RFID devices 108. The RFID reading system 225 transmits identifying information of the detected RFID devices 108 to the central control unit 215.

It is noted that camera 210 is a device that records images, either as a still image or as moving images (e.g., videos or movies). In this embodiment, when the actuation device 220 is triggered, the remote control unit 230 also forwards an instruction to capture a still image or video (also referred to herein as “visual media”) to the camera 210, via the central control unit 215. The camera 210 captures the visual media and transmits the visual media to the central control unit 215. In additional embodiments, when the media capturing center 105a also includes a microphone 235 and a recorder 240, the remote control unit 230 forwards an instruction to capture audio (also referred to herein as “audio media”) to the recorder 240. The recorder captures the audio and transmits the audio to the central control unit 215.

The central control unit 215 creates a media file including the identifying information of a detected RFID device and the visual and/or audio media. If the central control unit 215 receives identifying information of multiple RFID devices 108, the central control unit 215 creates a separate media file for each such device 108. Then, the central control unit 215 transmits the media files over the network 115 to the media server 110.

In continued reference to FIG. 2, and in further detail, the camera 210 can be oriented towards at least one visually distinguishing mark 245 at a fixed, predetermined location. The visually distinguishing mark 245 can define the preferred area where customers should stand to have their image taken. The visually distinguishing marks 245 can be placed on the ground or other surroundings. In various embodiments, the marks 245 can be painted images, such as lines, rectangles, ellipses, or corporate logos on pavement, a grass field, and/or a wall. In additional embodiments, the marks 245 can be created with colored lights illuminating or outlining the area. In further embodiments, the marks 245 can be a component of the scene, such as a change in color of a water slide.

The antennae 250a, 250b, 250c, 250d, (collectively, “250”) of the RFID reading system 225 can be positioned proximate to the visually distinguishing marks 245. Thus, the antennae 250 can define an area where the RFID reading system 225 detects RFID devices 108. In various embodiments, the antennae 250 of the RFID reading system 225 can be positioned adjacent to, below, or above the defined area. For example, the antennae 250 can be suspended from a ceiling to surround a painting in a museum. In further examples, the antennae 250 can be embedded in pavement under the entrance gate of a ski resort or in front of a landmark in a theme park.

When the RFID reading system 225 receives an instruction to detect RFID devices 108, the RFID reading system 225 detects identifying information of RFID devices 108 within the range of the antennae 250. The RFID reader 260 can sort the identifying information from the antennae 250 using the RFID multiplexer 255 before transmitting the identifying information to the central control unit 215 to be included in a media file.

In continued reference to FIG. 2, a customer can use the actuation devices 220 to control the camera 210. When a customer operates an actuation device 220, the device 220 transmits an instruction to the central control unit 215 via the remote control unit 230. The central control unit 215 controls the camera 210 according to the instruction.

In various embodiments, the actuation devices 220 can generate instructions to operate the camera 210. For example, such operations can include pan, zoom, capture an image, capture video, and/or capture audio. For example, actuation device 220a can instruct the camera to “zoom in” and actuation device 220b can instruct the camera to “zoom out.” Each depression of an actuation device 220a or 220b can result in a camera zoom by a predetermined increment. If the customer keeps the actuation device 220a or 220b depressed, the camera 210 can continue to zoom.

Another actuation device 220c can control the camera 210 to capture an image. In some embodiments, if the customer depresses and holds the actuation device 220c, the camera 210 can capture video. The camera 210 can continue to capture video until the customer releases the actuation device 220c or a maximum time duration programmed into the camera elapses. Likewise, the remote control unit 230 can instruct the recorder 240 to record audio using the microphone 235 while the camera 210 records video.

Furthermore, the actuation devices 220 can be positioned within or proximate to the area defined by the visually distinguishing marks 245 for accessibility to the customer. In various embodiments, the actuation devices 220 are mechanical switches or buttons. In some embodiments, the actuation devices 220 are foot activated and/or hand activated. Customers can operate such actuation devices 220 by depressing the switches or buttons.

In some embodiments, actuation of any actuation device 220 activates a display device 218 from a low power mode. Upon activation, the display device 218 renders images being captured by the camera 210. Thus, a customer can view the image the camera 210 would capture and adjust the camera 210 accordingly. If a period of time elapses without any of the actuation devices 220 being depressed, the display device 218 can return to a low power mode.

The embodiment of the media capturing system 105a described in reference to FIG. 2 can be arranged in numerous, diverse settings and configurations. In one example, a media capturing system 105 can be positioned at the entrance or exit of a theme park. The camera 210 can be oriented towards a landmark, such as Cinderella's Castle at Disney World, at the entrance or exit. A painted box on the ground can indicate where customers should stand for a photographic opportunity. The RFID reading system 225 can be embedded in the pavement under the painted box to read RFID devices 108 of customers within the box. Foot activated switches can be positioned within the painted box, and a customer can activate the switches to pan or zoom the camera to a desired position. When the customer activates the switch to take an image, the camera captures an image and the RFID reading system detects the identifying information of RFID devices 108 within the painted box on the ground. The central control unit 215 creates media files, each media file including the captured image and identifying information of one of the detected RFID devices 108.

In another example, a media capturing system can be positioned on gondolas at a ski resort. The RFID reading system 225 and actuation devices 220 can be positioned on or under the seat of a first gondola. In this example, the actuation devices 220 can be buttons. The camera 210 can be positioned on a second gondola in front of the first gondola and oriented to face the skiers on the first gondola. The central control unit 215 can be positioned on either the first or second gondola. When a skier presses a button on the first gondola, the RFID reading system 225 detects identifying information of RFID devices 108 of skiers in the first gondola. Also, the camera 210 in the second gondola captures an image. The central control unit 215 creates media files from the captured image and detected identifying information and transmits the media files to the media server 110.

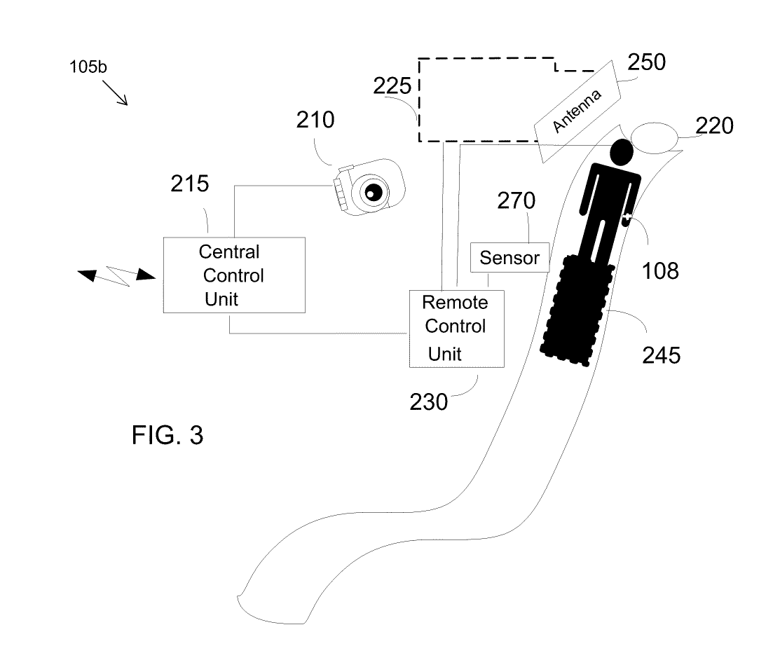

Referring now to FIG. 3, a second embodiment of a media capturing center 105b is shown and described. The media capturing center 105b includes an actuation device 220 positioned remotely from a camera 210 oriented towards a visually distinguishing mark 245, the visually distinguishing mark 245 indicating where the camera 210 will capture an image. When a customer actuates the actuation device 220, the remote control unit 230 instructs the RFID reading system 225 to detect RFID devices 108 and activates the sensor 270 (e.g., an optical sensor) oriented towards the mark 245. The RFID reading system 225 transmits identifying information of the detected devices 108 within range of the antennae 250 to the central control unit 215.

Once the sensor 270 is activated, the sensor 270 detects movement proximate to the visually distinguishing mark, e.g., when a customer passes the mark 245. Upon such detection, the sensor 270 transmits to the camera 210 an instruction to capture an image, via the remote control unit 230 and the central control unit 215. The camera 210 transmits the captured image to the central control unit 215. The central control unit 215 creates a media file including the identifying information and the captured image and transmits the media file to the media server 110, as described in reference to FIG. 2.

In continued reference to FIG. 3, the central control unit 215 can store in a queue a plurality of identifying information of detected RFID devices 108. In these situations, customers in a line actuate the actuation device 220 to indicate they want their image captured. Each time a customer actuates the actuation device 220, the RFID reading system 225 detects the RFID device 108 of the customer. The central control unit 215 places the identifying information in a queue. As the sensor 270 detects each customer passing the visually distinguishing mark 45, the camera 210 captures an image of the customer and transmits the image to the central control unit 215. The central control unit 215 retrieves identifying information from the front of the queue and creates a media file including the retrieved information and the captured image. In this manner, if customers pass the visually distinguishing marks 45 in the order that they actuated the actuation device 220, the central control unit 215 creates media files that match captured images with the identifying information of the customers' RFID devices 108.

In operation, in response to the actuation device 220, the remote control unit 230 can activate the sensor 270 from a low power state. In some embodiments, the sensor 270 returns to a low power state if the actuation device 220 is not actuated within a predetermined period of time. In other embodiments, the sensor 270 returns to a lower power state if the sensor 270 does not detect a customer passing the visually distinguishing marks 45 within a predetermined period of time. In these embodiments, the central control unit 215 can delete identifying information of a detected RFID device 108 on the assumption the customer no longer wants his image captured.

The embodiment of the media capturing system 105b described in reference to FIG. 3 can be arranged in numerous, diverse settings and configurations where the camera 210 is oriented towards visually distinguishing marks 45 remote from the actuation device 220. This embodiment 105b is installed along a waterslide in a water park. The actuation device 220 and RFID reading system 225 are positioned at the top of a waterslide. The RFID reading system 225 detects a customer's RFID device when the customer indicates, via the actuation device 220, he wants his image captured when he slides down the slide. As the customer slides, the sensor 270 detects when the customer is sliding past visually distinguishing marks 45 (e.g., a portion of the water slide with a different color). The camera 210 captures an image of the customer at the visually distinguishing marks 45 for the media file.

In another example, the media capturing center 105 is installed relative to a rollercoaster. As customers wait in line for the ride, the customers actuate the actuation device 220 to indicate they want their images captured during the ride. The RFID reading system 225 detects the RFID devices 108 and stores the identifying information of the devices 108 in a queue. When the rollercoaster passes the sensor 270 during the ride, the camera 210 in turn captures a succession of images. The central control unit 215 creates media files using the captured images and the identifying information in the queue.

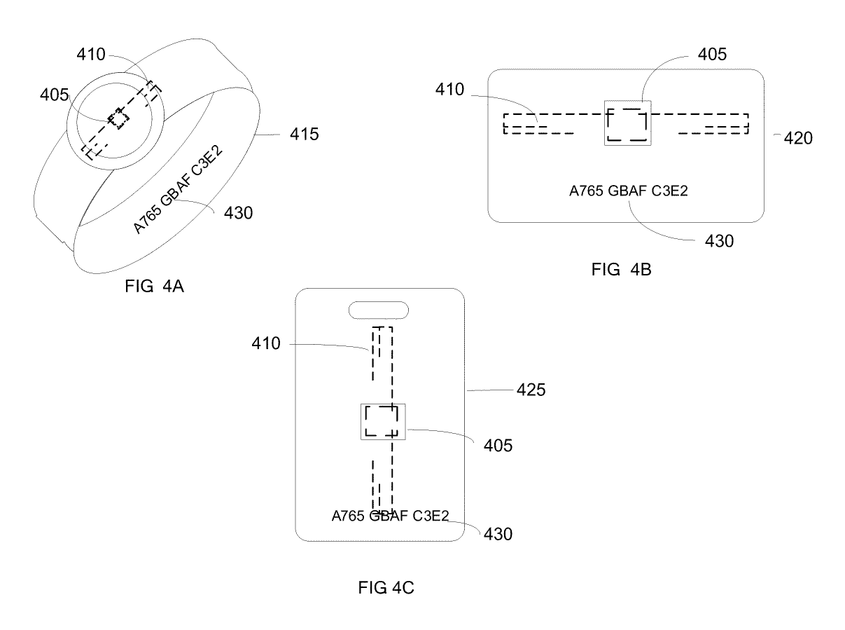

Referring now to FIGS. 4A-4C, the RFID device 108 can include an RFID tag chip 405 and an antenna 410. Each RFID device 108 can be pre-recorded with identifying information, such as a serial number, on the tag chip 405. The identifying information can be pre-recorded in the tag chip 405 during manufacture. An RFID device 108 can include additional identifying information 430 printed on the device 108 that can be used to retrieve media files associated with the device 108, in a manner described in detail herein below. The printed identifying information 430 can be a visual identifier. The visual identifier can include, for example, a sequence of alphanumeric characters. In some embodiments, the alphanumeric characters are printed in a hidden area of the RFID 108 device, such as the inside of the wristband 415 or under a covering of the card 420 or badge 425. The identifying information recorded on the tag chip 405 and the printed identifying information 430 can be derived from one another in any manner known to one of ordinary skill in the art, such as secret dependency functions or look-up tables.

The RFID device 108 can take the form of a wristband 415 (FIG. 4A), a card 420 (FIG. 4B), a badge 425 (FIG. 4C), or any other form as would be evident to one of ordinary skill in the art. In some embodiments, the RFID device 108 is a passive ultra-high frequency (UHF) RFID device.

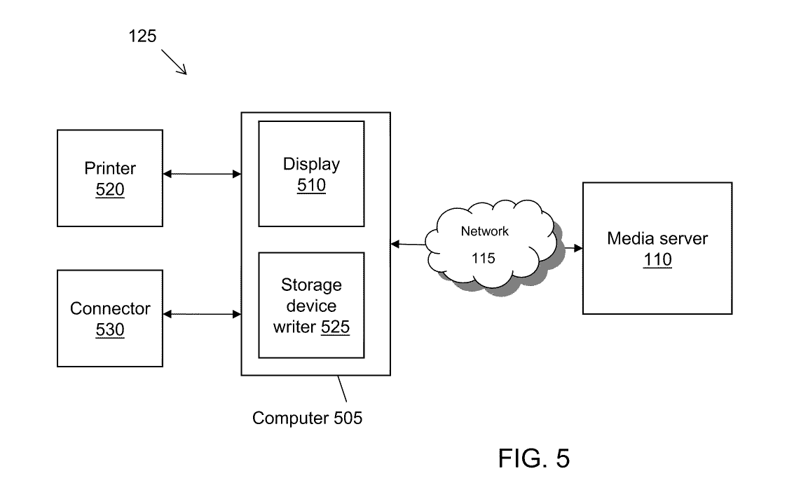

Referring now to FIG. 5, an exemplary block diagram of a media output terminal 125 is shown and described. In brief overview, the media output terminal 125 includes a computer 505 that can be installed with special ordering, media editing, and media output software. The computer 505 can connect over the network 115 to the media server 110. The computer 505 can include a display 510 for displaying retrieved media files for the customer and a payment terminal 515 that accepts credit or debit cards to pay for orders. The computer 505 can also include components for outputting media in various forms, such as a printer 520 to print images, a storage device writer 525 that records images or video on compact disks (CDs) or digital video disks (DVDs), and/or a connector 530 to transfer media files to external storage devices, such as memory sticks or cards.

In operation, the customer can input identifying information of his RFID device 108 to the display 510. In some embodiments, a group of customers can input the identifying information of their RFID devices 108. The computer 505 creates a request containing the received identifying information and transmits the request over the network 115 to the media server 110. The media server 110 identifies media files corresponding to the identifying information. In some embodiments, the media server 110 uses the received identifying information as an index into a database to retrieve media files that include the identifying information. In additional embodiments, the media server 110 derives additional identifying information from the received information and uses the derived information as the index. For example, the media server 110 may receive a visual identifier from an RFID device 108, derive a serial number from the visual identifier, and use the serial number to find media files that include the serial number.

The media server 110 transmits the media files to the computer 505, and the computer 505 displays the media files on the display 510. The customer can edit any of the media files to create final images or video. For example, the customer can crop an image, stitch images together to create a single image, correct white color balance, or remove audio from a video. The customer can also include a greeting on a message, the date the image or video was captured, or the names of the customers present in the image or video. The customer can select desired media and pay for the order via credit or debit card using the payment terminal 515. If the customer orders photographic prints, the customer can choose the size of the prints. The printer 520 creates the prints according to the customer's selections. If the customer orders media to be stored on a CD or DVD, or any similar device, the storage device writer 525 can record the media files on a CD or DVD to be provided to the customer. Lastly, the customer can connect his own external storage device to the connector 530 and request that selected media be transferred to the device.

In other examples, a customer can order images or video by visiting, via a client 120, a webpage hosted by the media server 110. As for the media output terminal 125, the customer can enter identifying information of the RFID device(s) 108 for which the customer wants to retrieve media files, and the media server 110 can transmit media files corresponding to the identifying information. The customer can edit any of the media files and select files for ordering. The media server 110 can direct the customer to a webpage for accepting payment via credit or debit card. The customer can specify the form in which the selected media files should be delivered. If the customer requests transfer of the files to the customer's client 120, the media server 110 transmits the files over the network 115 to the client 120. The customer can save the files on the client 120.

If the customer requests photographic prints or transfer of the files to a storage device, the media server 110 can log a corresponding order with a processing center. The processing center can produce the photographic prints according to the customer's order or package the selected media files on a CD or DVD. The processing center can then deliver the prints, CD, or DVD to the customer's address.

While the invention has been particularly shown and described with reference to specific embodiments, it should be understood by those skilled in the art that various changes in form and detail may be made therein without departing from the spirit and scope of the invention as defined by the appended claims.

1. A media management system, comprising:
a camera oriented towards a visually distinguishing mark;
at least one actuation device that generates an instruction for at least one of the camera and an RFID reading system; and
a central control unit in communication with the camera and the RFID reading system;
wherein the RFID reading system, in response to an instruction from the at least one actuation device,
i) detects an RFID device neighboring the visually distinguishing mark and
ii) transmits a first identifying information of the detected RFID device to the central control unit; and
wherein the central control unit
i) receives an image captured by the camera,
ii) creates a media file including the captured image and the received first identifying information, and
iii) transmits the media file to a server.

2. The media management system of claim 1, wherein the RFID reading system comprises a plurality of antennae positioned near the visually distinguishing mark to define an area where the RFID reading system detects the RFID device.

3. The media management system of claim 1, wherein the server stores the media file according to the first identifying information in the media file.

4. The media management system of claim 1, wherein the at least one actuation device can be triggered to transmit one of a zoom instruction, a pan instruction, and a media capture instruction to the camera.

5. The media management system of claim 1, wherein the camera captures the image in response to detection, by a sensor, of movement proximate to the visually distinguishing mark.

6. The media management system of claim 5, wherein the central control unit
i) stores in a queue a plurality of first identifying information of RFID devices detected by the RFID reading system;
ii) receives the captured image from the camera; and
iii) retrieves the first identifying information from the queue to include in the media file with the captured image.

7. The media management system of claim 1, further comprising a microphone and a recorder for capturing audio, wherein the media file includes the captured audio.

8. The media management system of claim 1, wherein the RFID device is at least one of a wristband, a badge, and a card.

9. The media management system of claim 1, wherein the first identifying information is pre-recorded in the RFID device and a second identifying information is visually depicted on the RFID device.

10. The media management system of claim 1, further comprising a media output terminal that receives second identifying information from a customer, derives the first identifying information from the second identifying information, retrieves media files corresponding to the first identifying information from the server, and transfers media from the media files to at least one of a printer, a storage media, and a computing device.

11. The media management system of claim 1, wherein the server receives second identifying information from a customer, derives the first identifying information from the second identifying information, retrieves media files corresponding to the first identifying information, and responds to a customer request via one of transferring the media files to a client device associated with the customer and generating an order to print images from media files and deliver the images to the customer.

12. A method of managing media comprising:
receiving, by a remote control unit, an instruction from a first actuation device to an RFID reading system to detect an RFID device;
actuating, by the remote control unit, the RFID reading system in response to the instruction;
detecting, by the RFID reading system, the RFID device neighboring a visually distinguishing mark;
transmitting, by the RFID reading system, first identifying information of the RFID device to a central control unit;
capturing, by a camera oriented towards the visually distinguishing mark, an image;
creating, by the central control unit, a media file including the first identifying information and the captured image; and
transmitting, by the central control unit, the media file to a server.

13. The method of claim 12, further comprising positioning a plurality of antennae of the RFID reading system near the visually distinguishing mark to define an area where the RFID reading system communicates with the RFID device.

14. The method of claim 12, further comprising storing, by the server, the media file according to the first identifying information in the media file.

15. The method of claim 12, further comprising receiving, by a second actuation device, an instruction to the camera to one of zoom, pan, and capture media.

16. The method of claim 12, wherein the camera captures the image in response to detection, by a sensor, of movement proximate to the visually distinguishing marks.

17. The method of claim 16, further comprising
storing, by the central control unit, in a queue a plurality of first identifying information of RFID devices detected by the RFID reading system;
receiving, by the central control unit, the captured image from the camera; and
retrieving, by the central control unit, first identifying information from the queue to include in the media file with the captured image.

18. The method of claim 12, further comprising capturing, by a microphone and recorder, audio to be included in the media file.

19. The method of claim 12, further comprising
receiving, by a media output terminal, second identifying information from a customer;
deriving, by the media output terminal, the first identifying information of the RFID device from the received second identifying information;
retrieving, by the media output terminal, media files from the server according to the first identifying information; and
transferring, by the media output terminal, the media files to at least one of a printer, a storage media, and a computing device.

20. The method of claim 12, further comprising
receiving, by the server, second identifying information from a customer;
deriving, by the server, the first identifying information of the RFID device from the received second identifying information;
retrieving, by the server, media files according to the first identifying information; and responding, by the server, to a customer request via one of transferring the media files to a client device associated with the customer and generating an order to print images from media files and deliver the images to the customer.
